(19) United States
(12) Patent Application Publication
(10) Pub. No.: US 2026/0222311 A1
(43) Pub. Date: Jul. 30, 2026

(54) TECHNIQUES FOR GRADIENT SIGNALING UNITARY PROJECTION IN FEDERATED LEARNING

(71) Applicant: QUALCOMM Incorporated, San Diego, CA (US)

(72) Inventors: Gideon Shlomo KUTZ, Ramat Hasharon (IL); Aviv REGEV, Tel Aviv (IL)

(21) Appl. No.: 19/039,018

(22) Filed: Jan. 28, 2025

(51) Int. Cl. H04L 41/16; G06N 3/098; H04L 25/02

(52) U.S. Cl. CPC H04L 41/16; G06N 3/098; H04L 25/0202

(57) ABSTRACT

Certain aspects of the present disclosure provide techniques for wireless communications. An example method includes identifying a plurality of gradients associated with federated learning at a node; projecting the plurality of gradients onto a plurality of signal components, wherein each gradient of the plurality of gradients is projected onto all signal components of the plurality of signal components; and transmitting a signal comprising the plurality of signal components.

### INTRODUCTION

### Field of the Disclosure

Aspects of the present disclosure relate to wireless communications, and more particularly, to techniques for gradient signaling unitary projection in federated learning.

### DESCRIPTION OF RELATED ART

Wireless communications systems are widely deployed to provide various telecommunication services such as telephony, video, data, messaging, broadcasts, or other similar types of services. These wireless communications systems may employ multiple-access technologies capable of supporting communications with multiple users by sharing available wireless communications system resources with those users.

Although wireless communications systems have made great technological advancements over many years, challenges still exist. For example, complex and dynamic environments can still attenuate or block signals between wireless transmitters and wireless receivers. Accordingly, there is a continuous desire to improve the technical performance of wireless communications systems, including, for example: improving speed and data carrying capacity of communications, improving efficiency of the use of shared communications mediums, reducing power used by transmitters and receivers while performing communications, improving reliability of wireless communications, avoiding redundant transmissions and/or receptions and related processing, improving the coverage area of wireless communications, increasing the number and types of devices that can access wireless communications systems, increasing the ability for different types of devices to intercommunicate, increasing the number and type of wireless communications mediums available for use, and the like. Consequently, there exists a need for further improvements in wireless communications systems to overcome the aforementioned technical challenges and others.

### SUMMARY

Certain aspects provide a method of wireless communication by a user equipment (UE). The method includes identifying a plurality of gradients associated with federated learning at the UE; projecting the plurality of gradients onto a plurality of signal components, wherein each gradient of the plurality of gradients is projected onto all signal components of the plurality of signal components; and transmitting a signal comprising the plurality of signal components.

Certain aspects provide a method of wireless communication by a network entity. The method comprises receiving, from a plurality of nodes, a signal comprising a plurality of signal components; obtaining, from the plurality of signal components and using an inverse of a unitary projection matrix, a plurality of gradients associated with federated learning at the plurality of nodes; updating a model parameter based on the plurality of gradients; and transmitting, to the plurality of nodes, an indication of the updated model parameter

Other aspects provide: one or more apparatuses operable, configured, or otherwise adapted to perform any portion of any method described herein (e.g., such that performance may be by only one apparatus or in a distributed fashion across multiple apparatuses); one or more non-transitory, computer-readable media comprising instructions that, when executed by one or more processors of one or more apparatuses, cause the one or more apparatuses to perform any portion of any method described herein (e.g., such that instructions may be included in only one computer-readable medium or in a distributed fashion across multiple computer-readable media, such that instructions may be executed by only one processor or by multiple processors in a distributed fashion, such that each apparatus of the one or more apparatuses may include one processor or multiple processors, and/or such that performance may be by only one apparatus or in a distributed fashion across multiple apparatuses); one or more computer program products embodied on one or more computer-readable storage media comprising code for performing any portion of any method described herein (e.g., such that code may be stored in only one computer-readable medium or across computer-readable media in a distributed fashion); and/or one or more apparatuses comprising one or more means for performing any portion of any method described herein (e.g., such that performance would be by only one apparatus or by multiple apparatuses in a distributed fashion). By way of example, an apparatus may comprise a processing system, a device with a processing system, or processing systems cooperating over one or more networks. An apparatus may comprise one or more memories; and one or more processors configured to cause the apparatus to perform any portion of any method described herein. In some examples, one or more of the processors may be preconfigured to perform various functions or operations described herein without requiring configuration by software.

The following description and the appended figures set forth certain features for purposes of illustration.

### BRIEF DESCRIPTION OF DRAWINGS

The appended figures depict certain features of the various aspects described herein and are not to be considered limiting of the scope of this disclosure.

FIG. 1 depicts an example wireless communications network.

FIG. 2 depicts an example disaggregated base station architecture.

FIG. 3 depicts aspects of network entities and a user equipment (UE).

FIGS. 4A, 4B, 4C, and 4D depict various example aspects of data structures for a wireless communications network.

FIG. 5 is a diagram of an example environment associated with federated learning.

FIG. 6 is a diagram illustrating an example of gradient signaling without projection, and an example of gradient signaling with projection onto a plurality of subcarriers.

FIG. 7 is a diagram illustrating an example of signaling for projection of gradient indications onto a plurality of subcarriers.

FIG. 8 depicts a method for wireless communications.

FIG. 9 depicts aspects of an example communications device.

### DETAILED DESCRIPTION

Aspects of the present disclosure provide apparatuses, methods, processing systems, and computer-readable mediums for gradient signaling power scaling in federated learning.

A user equipment (UE) operating in a network may utilize a machine learning component for any number of different types of operations, transmissions, user experience enhancements, and/or the like. For example, in some cases, a UE may use one or more machine learning components to report, to a base station, information associated with received signals, user interactions with the UE, and/or positioning information, among other examples. For example, a UE may perform measurements associated with reference signals and use one or more machine learning components to facilitate reporting the measurements to a base station. In some examples, the UE may measure reference signals during a beam management process for channel state feedback (CSF), may measure received power of reference signals from a serving cell and/or neighbor cells, may measure signal strength of inter-radio access technology (e.g., WiFi) networks, may measure sensor signals for detecting locations of one or more objects within an environment, and/or the like. In some examples, a UE may use one or more machine learning components to use data associated with a user's interaction with the UE to customize or otherwise enhance a user experience with a user interface.

A machine learning component is a component (e.g., hardware, software, or a combination thereof) of a device (e.g., a client device, a server device, a UE, a base station, etc.) that performs one or more machine learning procedures. A machine learning component may include, for example, hardware and/or software that may learn to perform a procedure without being explicitly trained to perform the procedure. A machine learning component may include, for example, a feature learning processing block and/or a representation learning processing block. A machine learning component may include one or more neural networks. A neural network may include, for example, an autoencoder.

In some cases, machine learning components may be trained using federated learning. Federated learning is a machine learning technique that enables multiple clients to collaboratively train machine learning models based on training data, while the server device does not collect the training data from the client devices. Federated learning techniques may involve one or more global neural network models trained from data stored on multiple client devices (e.g., UEs).

In federated learning, various nodes (e.g., UEs) determine and report model parameters to a network entity (e.g., gNB, training server, etc.). The network entity may combine the model parameters, such as by averaging the model parameters or the like, to determine a selected value for the model parameters. The network entity may send the selected value for the model parameters back to the UEs. This process may be repeated until convergence is obtained. The model parameters may include, for example, weights of a model, biases of a model, gradients that indicate a change in a model parameter, or the like.

In some cases, model parameters can be reported as physical layer signaling (e.g., rather than a data transmission that includes data that indicates the model parameters). For example, a node may transmit an analog signal that represents a model parameter (e.g., a signal in a first resource or with a first configuration may represent a first value of the model parameter, a signal in a second resource or with a second configuration may represent a second value of the model parameter, and so on). The network entity may receive a signal that comprises a sum of all the analog signals transmitted by the set of nodes. Thus, the model parameters are combined “over the air” in a process referred to as “over-the-air (OTA) averaging”. OTA averaging may reduce overhead relative to data-based transmission of model parameters since all nodes of a set of nodes can transmit the model parameters on the same set of resources. In the context of gradient signaling, for k nodes (e.g., UEs), a gradient \hat{θ}ᵢ may be signaled by each of the k nodes for i=0 . . . k, and a received channel Y at the network entity may be received as

$$Y = {\sum }_{i = 1}^{K} {\hat{θ}}_{i} + n ,$$

where n is noise.

Wireless channels typically have some amount of interference, attenuation, clusters, and so on. This can lead to a first analog signal for OTA transmission being received at a different strength than a second analog signal for OTA transmission due to channel characteristics (where the channel at a subcarrier n is represented by and referred to as a channel matrix hₙ). To mitigate the effects of the channel hₙ the set of nodes (and the network entity) may apply pre-equalization to the analog signals. When applying pre-equalization, the averaged model parameter, for a jth model parameter, can be denoted as

$${w}_{j} = {\sum }_{n} {h}_{n} ( {h}_{n}^{- 1} {w}_{j , n} ) ,$$

where hₙ⁻¹ denotes an inverse of the channel matrix (including phase information). This pre-equalization using the inverse of the channel matrix is achievable when channel reciprocity is applicable, since the nodes (e.g., UEs) can estimate the uplink channel from a received downlink signal.

Though OTA averaging (also referred to as OTA aggregation) is beneficial for model parameter signaling, several factors can lead to degradation of the signaling of the model parameters. One such factor is inconsistent channel performance. For example, even though pre-equalization can compensate channel effects to some degree, channel conditions can change quickly, and thus the channel information (e.g., hₙ) may become outdated, leading to uneven performance from subcarrier to subcarrier. As a specific example, in the presence of outdated channel estimation, the received averaged gradient on the jth subcarrier is distorted and given by

$${w}_{j} = {\sum }_{n} {h}_{n , j , t 1} ( {h}_{n , j , t 0}^{- 1} {w}_{j , n} ) ,$$

where h_{n,j,t} is the channel response from the nth user, at the jth sub carrier at time t, t0 is the channel estimation time based on which the pre-equalization is calculated, and t1 is the time of the actual OTA transmission. The overall distortion at the receiver's jth sub-carrier is

$${d}_{j} = E ( {\vert {\sum }_{n} {h}_{n , j , t 1} ( {h}_{n , j , t 0}^{- 1} {w}_{j , n} ) - {\sum }_{n} {w}_{j , n} + {v}_{j} \vert}^{2} ) ,$$

where vⱼ is the additive white Gaussian noise (AWGN) received at the jth sub-carrier. The signal-to-noise ratio (SNR) of the jth sub-carrier (gradient) is SNRⱼ=E(|Σₙw_{j,n}|²/dⱼ). These problematic sub-carriers are hard to predict and might impact any gradient. As a result, the AI training convergence is impaired.

Aspects of the present disclosure relate generally to OTA aggregation for gradient signaling. Some aspects more specifically relate to diversifying (on a frequency basis) gradient transmission by projecting a plurality of gradient values over a plurality of resources. For example, a node (such as a UE) may transmit a plurality of gradient indications on a plurality of subcarriers. Rather than transmitting each gradient indication only on a respective subcarrier, of a plurality of subcarriers, to which each gradient indication pertains, the node may project each gradient indication onto multiple subcarriers, such as each subcarrier of the plurality of subcarriers. For example, the node may use a unitary projection (e.g., a unitary projection matrix D) such that each gradient indication is even distributed over the plurality of subcarriers. At the receiver (e.g., network entity), the receiver may apply an inverse projection (D^{H}) to the received signal such that the gradient indications are mapped to (only) the respective subcarriers to which the gradient indications apply. Thus, the effect of inconsistent subcarrier performance is mitigated by projecting each of the gradient indications onto all of the subcarriers and applying the inverse projection at the receiver, thereby improving the consistency of signal-to-noise ratios across the subcarriers. In some aspects, the same unitary projection matrix is used by all nodes of a set of nodes, which enables the network entity to extract the relevant gradient values. Furthermore, in some aspects, different unitary projection matrixes may be used across different network entities so that inter-network-entity (e.g., inter-gNB) interference is reduced.

### Introduction to Wireless Communications Networks

The techniques and methods described herein may be used for various wireless communications networks. While aspects may be described herein using terminology commonly associated with 3G, 4G, 5G, 6G, and/or other generations of wireless technologies, aspects of the present disclosure may likewise be applicable to other communications systems and standards not explicitly mentioned herein.

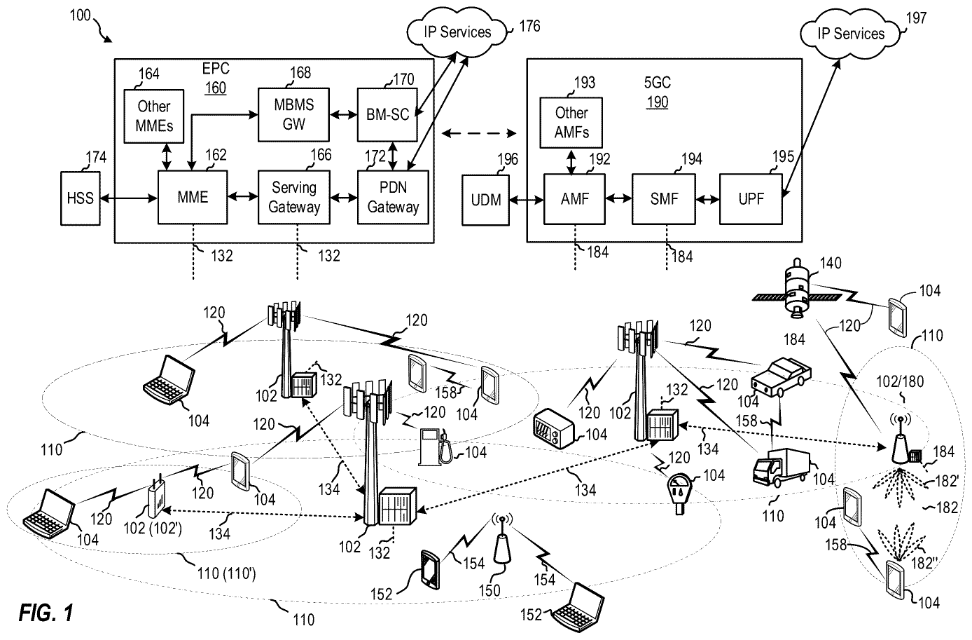

FIG. 1 depicts an example of a wireless communications network 100, in which aspects described herein may be implemented.

Generally, wireless communications network 100 includes various network entities (alternatively, network elements or network nodes). A network entity is generally a communications device and/or a communications function performed by a communications device (e.g., a user equipment (UE), a base station (BS), a component of a BS, a server, etc.). As such communications devices are part of wireless communications network 100, and facilitate wireless communications, such communications devices may be referred to as wireless communications devices. For example, various functions of a network as well as various devices associated with and interacting with a network may be considered network entities. Further, wireless communications network 100 may include terrestrial aspects, such as ground-based network entities (e.g., BSs 102), and non-terrestrial aspects (also referred to herein as non-terrestrial network entities). A non-terrestrial network entity may include satellite 140, which may be an example of an aerial or space-borne platform. In some examples, satellite 140 may include one or more network entities on-board (e.g., one or more BSs) capable of communicating with other network elements (e.g., terrestrial BSs) and UEs. For example, satellite 140 may be implemented according to a regenerative architecture (also referred to as a non-transparent architecture), and a gNB implemented at satellite 140 may implement higher-layer network functions. As another example, satellite 140 may be implemented according to a transparent architecture, and may perform a physical or other lower-layer repeater function for UEs and a network entity (such as a gateway associated with the satellite 140).

In the depicted example, wireless communications network 100 includes BSs 102, UEs 104, and one or more core networks, such as an Evolved Packet Core (EPC) 160 or a 5G Core (5GC) network 190, which interoperate to provide communications services over various communications links, including wired and wireless links. In some aspects, a core network, such as a 6G core, may implement a converged service-based architecture. In a converged service-based architecture, functions traditionally split between a core network (such as 5GC network 190) and a radio access network (RAN) (such as BS 102) may be implemented at a single network entity. For example, a mobility network entity may perform both core network functions and RAN functions related to mobility of UEs 104 attached to the wireless communications network 100. “Network entity” can refer to a BS 102, a network entity of EPC 160 or 5GC network 190, or a network entity of a converged service-based architecture.

FIG. 1 depicts various example UEs 104. UE 104 may include a cellular phone, a smart phone, a session initiation protocol (SIP) phone, a laptop, a personal digital assistant (PDA), a satellite radio, a Global Positioning System device, a multimedia device, a video device, a digital audio player, a camera, a game console, a tablet, a smart device, a wearable device, a vehicle, an electric meter, a gas pump, a kitchen appliance, a healthcare device, an implant, a sensor/actuator, a display, an Internet of Things (IOT) device, an always on (AON) device, an edge processing device, a data center, or another similar device. A UE 104 may also be referred to as a mobile device, a wireless device, a station, a mobile station, a subscriber station, a mobile subscriber station, a mobile unit, a subscriber unit, a wireless unit, a remote unit, a remote device, an access terminal, a mobile terminal, a wireless terminal, a remote terminal, a handset, and others.

BSs 102 wirelessly communicate with (e.g., transmit signals to or receive signals from) UEs 104 via communications links 120. A communications link 120 between a BS 102 and a UE 104 may include uplink (UL) (also referred to as reverse link) transmissions from a UE 104 to a BS 102 and/or downlink (DL) (also referred to as forward link) transmissions from a BS 102 to a UE 104. A communications link 120 may use multiple-input and multiple-output (MIMO) antenna technology, including spatial multiplexing, beamforming, and/or transmit diversity in various aspects.

A BS 102 may include a NodeB, an enhanced NodeB (eNB), a next generation enhanced NodeB (ng-eNB), a next generation NodeB (gNB or gNodeB), an access point, a base transceiver station, a radio base station, a radio transceiver, a transceiver function, a transmission reception point (TRP), a radio unit (RU), a distributed unit (DU), or the like. A given BS 102 may provide communications coverage for a coverage area 110, which may sometimes be referred to as a cell, and which may overlap another coverage area 110 (e.g., a small cell provided by a BS 102′) may have a coverage area 110′ that overlaps the coverage area 110 of a macro cell). A BS 102 may, for example, provide communications coverage for a macro cell (covering a relatively large geographic area), a pico cell (covering a relatively smaller geographic area, such as a sports stadium), a femto cell (covering a relatively smaller geographic area, such as a home), or another type of cell.

The term “cell” may refer to a portion, partition, or segment of wireless communication coverage served by a network entity within a wireless communications network 100. A cell may have geographic characteristics, such as a geographic coverage area, as well as radio frequency characteristics, such as time and/or frequency resources dedicated to the cell. For example, a specific geographic coverage area may be covered by multiple cells employing different frequency resources (e.g., bandwidth parts) and/or different time resources. As another example, a specific geographic coverage area may be covered by a single cell. In some contexts (e.g., a carrier aggregation scenario and/or multi-connectivity scenario), the terms “cell” or “serving cell” may refer to or correspond to a specific carrier frequency (e.g., a component carrier) used for wireless communications, and a “cell group” may refer to or correspond to multiple carriers used for wireless communications. As examples, in a carrier aggregation scenario, a UE may communicate on multiple component carriers corresponding to multiple (serving) cells in the same cell group, and in a multi-connectivity (e.g., dual connectivity) scenario, a UE may communicate on multiple component carriers corresponding to multiple cell groups.

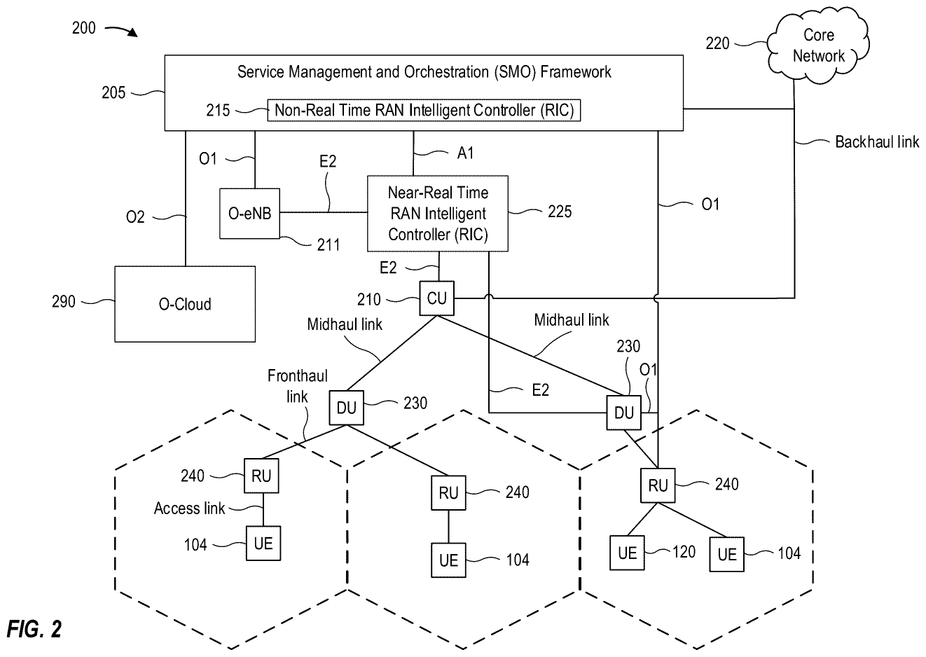

While BSs 102 are depicted in various aspects as unitary communications devices, BSs 102 may be implemented in various configurations. For example, one or more components of a base station may be disaggregated, including a central unit (CU), one or more DUs, one or more RUs, a Near-Real Time (Near-RT) RAN Intelligent Controller (RIC), or a Non-Real Time (Non-RT) RIC, to name a few examples. In another example, various aspects of a base station may be virtualized. A base station (e.g., BS 102) may include components that are located at a single physical location or components located at various physical locations. In examples in which a base station includes components that are located at various physical locations, the various components may each perform functions such that, collectively, the various components achieve functionality that is similar to a base station that is located at a single physical location. Implementing a base station in this fashion may provide efficiency gains by enabling cloud-based implementation of certain (e.g., non-time-sensitive) higher-layer functions while physical-layer or other lower-layer functions can be implemented at or in proximity to a geographic coverage area of a corresponding cell. In some aspects, a base station including components that are located at various physical locations may be referred to as having a disaggregated RAN architecture, such as an Open RAN (O-RAN) or Virtualized RAN (VRAN) architecture. FIG. 2 depicts and describes an example disaggregated RAN architecture.

Different BSs 102 within wireless communications network 100 may also be configured to support different radio access technologies, such as 3G, 4G, 5G, and/or 6G. For example, BSs 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., an S1 interface). BSs 102 configured for 5G (e.g., 5G NR or Next Generation RAN (NG-RAN)) may interface with 5GC 190 through second backhaul links 184. BSs 102 may communicate directly or indirectly (e.g., through the EPC 160 or the 5GC 190) with each other over third backhaul links 134 (e.g., an X2 or XN interface), which may be wired or wireless.

Wireless communications network 100 may subdivide the electromagnetic spectrum into various classes, bands, channels, or other features. In some aspects, the subdivision is provided based on wavelength and frequency, where frequency may also be referred to as a carrier, a subcarrier, a frequency channel, a tone, or a subband. For example, the Third Generation Partnership Project (3GPP) currently defines Frequency Range 1 (FR1) as including 410 MHz-7125 MHz, which is often referred to (interchangeably) as “Sub-6 GHz”. Similarly, 3GPP currently defines Frequency Range 2 (FR2) as including 24,250 MHz-71,000 MHz, which is sometimes referred to (interchangeably) as a “millimeter wave” (“mmW” or “mm Wave”). In some cases, FR2 may be further defined in terms of sub-ranges, such as a first sub-range FR2-1 including 24,250 MHz-52,600 MHz and a second sub-range FR2-2 including 52,600 MHz-71,000 MHz. A base station configured to communicate using mmWave/near mmWave radio frequency bands (e.g., a mmWave base station such as BS 180) may utilize beamforming (e.g., 182) with a UE (e.g., 104) to improve path loss and range.

A communications links 120 may be through one or more carriers, which may have different bandwidths (e.g., 5 MHz, 10 MHz, 15 MHz, 20 MHz, 100 MHz, 400 MHZ, and/or other bandwidths), and which may be aggregated in various aspects. Carriers may or may not be adjacent to each other. Allocation of carriers may be asymmetric with respect to DL and UL (e.g., more or fewer carriers may be allocated for DL than for UL).

Communications using higher frequency bands may have higher path loss and a shorter range compared to lower frequency communications. Accordingly, certain base stations (e.g., base station 180 in FIG. 1) may utilize beamforming (indicated by reference number 182) with a UE 104 to improve path loss and range. For example, BS 180 and the UE 104 may each include a plurality of antennas, such as antenna elements, antenna panels, and/or antenna arrays to facilitate the beamforming. In some cases, BS 180 may transmit a beamformed signal to UE 104 in one or more transmit directions 182′. UE 104 may receive the beamformed signal from the BS 180 in one or more receive directions 182″. UE 104 may also transmit a beamformed signal to the BS 180 in one or more transmit directions 182″. BS 180 may also receive the beamformed signal from UE 104 in one or more receive directions 182′. BS 180 and UE 104 may perform beam training to determine suitable receive and transmit directions for each of BS 180 and UE 104. Notably, the transmit and receive directions for BS 180 may or may not be the same. Similarly, the transmit and receive directions for UE 104 may or may not be the same.

Wireless communications network 100 may include a Wi-Fi access point (AP) 150 in communication with Wi-Fi stations (STAs) 152 via communications links 154 in, for example, a 2.4 GHz and/or 5 GHz unlicensed frequency spectrum.

Certain UEs 104 may communicate with each other using device-to-device (D2D) communications link 158. In some examples, D2D communications link 158 may use one or more sidelink channels, such as a physical sidelink broadcast channel (PSBCH), a physical sidelink discovery channel (PSDCH), a physical sidelink shared channel (PSSCH), a physical sidelink control channel (PSCCH), and/or a physical sidelink feedback channel (PSFCH). D2D communications link 158 may be implemented using a variety of technologies, such as a radio access technology (e.g., 5G, ProSe sidelink), a WiFi technology, a Bluetooth technology, or the like.

EPC 160 may include various functional components, such as a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and/or a Packet Data Network (PDN) Gateway 172. MME 162 may be in communication with a Home Subscriber Server (HSS) 174. MME 162 is a control node that processes signaling between the UEs 104 and the EPC 160. Generally, MME 162 provides bearer and connection management.

Generally, user Internet protocol (IP) packets are transferred through Serving Gateway 166. Serving gateway 166 is connected to PDN Gateway 172. PDN Gateway 172 provides UE IP address allocation as well as other functions. PDN Gateway 172 and BM-SC 170 are connected to IP Services 176, which may include, for example, the Internet, an intranet, an IP Multimedia Subsystem (IMS), a Packet Switched (PS) streaming service, and/or other IP services.

BM-SC 170 may provide functions for MBMS user service provisioning and delivery. BM-SC 170 may serve as an entry point for content provider MBMS transmission, may be used to authorize and initiate MBMS Bearer Services within a public land mobile network (PLMN), and/or may be used to schedule MBMS transmissions. MBMS Gateway 168 may be used to distribute MBMS traffic to the BSs 102 belonging to a Multicast Broadcast Single Frequency Network (MBSFN) area broadcasting a particular service, and/or may be responsible for session management (start/stop) and for collecting eMBMS related charging information.

5GC 190 may include various functional components, such as an Access and Mobility Management Function (AMF) 192, other AMFs 193, a Session Management Function (SMF) 194, and a User Plane Function (UPF) 195. AMF 192 may be in communication with Unified Data Management (UDM) 196.

AMF 192 is a control node that processes signaling between UEs 104 and the 5GC 190. AMF 192 provides, for example, quality of service (QoS) flow and session management.

IP packets are transferred through UPF 195, which is connected to the IP Services 197. UPF 195 may provide UE IP address allocation as well as other functions for 5GC 190. IP Services 197 may include, for example, the Internet, an intranet, an IMS, a PS streaming service, and/or other IP services.

In various aspects, a network entity or network node can be implemented as an aggregated base station, as a disaggregated base station, a component of a base station, an integrated access and backhaul (IAB) node, a relay node, a core network entity, or a sidelink node, to name a few examples.

FIG. 2 depicts an example disaggregated base station 200 architecture. The disaggregated base station 200 architecture may include one or more CUs 210 that can communicate directly with a core network 220 or other CUs 210 via a backhaul link (such as backhaul link 134), or indirectly with the core network 220 through one or more disaggregated base station units (such as a Near-Real Time (Near-RT) RAN Intelligent Controller (RIC) 225 via an E2 link, a Non-Real Time (Non-RT) RIC 215 associated with a Service Management and Orchestration (SMO) Framework 205, or both). A CU 210 may communicate with one or more DUs 230 via respective midhaul links, such as an F1 interface. The DUs 230 may communicate with one or more RUs 240 via respective fronthaul links. The RUs 240 may communicate with respective UEs 104 via one or more radio frequency (RF) access links (such as communication link 120). In some implementations, a UE 104 may be simultaneously served by multiple RUs 240.

Each of the units, e.g., the CUS 210, the DUs 230, the RUs 240, as well as the Near-RT RICs 225, the Non-RT RICs 215 and the SMO Framework 205, may include one or more interfaces or be coupled to one or more interfaces configured to receive or transmit signals, data, or information (collectively, signals) via a wired or wireless transmission medium. Each of the units, or a processor or controller providing instructions to the interfaces of the units, can be configured to communicate with one or more of the other units via the transmission medium. For example, the units can include a wired interface configured to receive or transmit signals over a wired transmission medium to one or more of the other units. Additionally or alternatively, the units can include a wireless interface, which may include a receiver, a transmitter, or a transceiver (such as a RF transceiver), configured to receive or transmit signals, or both, over a wireless transmission medium.

In some aspects, the CU 210 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 210. The CU 210 may be configured to handle user plane functionality (e.g., Central Unit-User Plane (CU-UP)), control plane functionality (e.g., Central Unit-Control Plane (CU-CP)), or a combination thereof. In some implementations, the CU 210 can be logically split into one or more CU-UP units and one or more CU-CP units. The CU-UP unit can communicate bidirectionally with the CU-CP unit via an interface, such as the E1 interface when implemented in an O-RAN configuration. The CU 210 can be implemented to communicate with the DU 230 for network control and signaling.

The DU 230 may be or correspond to a logical unit that includes one or more base station functions to control the operation of one or more RUs 240. In some aspects, the DU 230 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3^{rd} Generation Partnership Project (3GPP). In some aspects, the DU 230 may further host one or more low PHY layers. Each layer (or module) can be implemented with an interface configured to communicate signals with other layers (and modules) hosted by the DU 230, or with the control functions hosted by the CU 210.

Lower-layer functionality can be implemented by one or more RUs 240. In some deployments, an RU 240, controlled by a DU 230, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 240 can be implemented to handle over the air (OTA) communications with one or more UEs 104. In some implementations, real-time and non-real-time aspects of control and user plane communications with the RU(s) 240 can be controlled by the corresponding DU 230. In some scenarios, this configuration can enable the DU(s) 230 and the CU 210 to be implemented in a cloud-based RAN architecture, such as a vRAN architecture.

The SMO Framework 205 may be configured to support RAN deployment and provisioning of non-virtualized and virtualized network elements. For non-virtualized network elements, the SMO Framework 205 may be configured to support the deployment of dedicated physical resources for RAN coverage requirements which may be managed via an operations and maintenance interface (such as an O1 interface). For virtualized network elements, the SMO Framework 205 may be configured to interact with a cloud computing platform (such as an open cloud (O-Cloud) 290) to perform network element life cycle management (such as to instantiate virtualized network elements) via a cloud computing platform interface (such as an O2 interface). Such virtualized network elements can include, but are not limited to, CUs 210, DUs 230, RUs 240 and Near-RT RICs 225. In some implementations, the SMO Framework 205 can communicate with a hardware aspect of a 4G RAN, such as an open eNB (O-eNB) 211, via an O1 interface. Additionally, in some implementations, the SMO Framework 205 can communicate directly with one or more DUs 230 and/or one or more RUs 240 via an O1 interface. The SMO Framework 205 also may include a Non-RT RIC 215 configured to support functionality of the SMO Framework 205.

The Non-RT RIC 215 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 225. The Non-RT RIC 215 may be coupled to or communicate with (such as via an A1 interface) the Near-RT RIC 225. The Near-RT RIC 225 may be configured to include a logical function that enables near-real-time control and optimization of RAN elements and resources via data collection and actions over an interface (such as via an E2 interface) connecting one or more CUs 210, one or more DUs 230, or both, as well as an O-eNB, with the Near-RT RIC 225.

In some implementations, to generate AI/ML models to be deployed in the Near-RT RIC 225, the Non-RT RIC 215 may receive parameters or external enrichment information from external servers. Such information may be utilized by the Near-RT RIC 225 and may be received at the SMO Framework 205 or the Non-RT RIC 215 from non-network data sources or from network functions. In some examples, the Non-RT RIC 215 or the Near-RT RIC 225 may be configured to tune RAN behavior or performance. For example, the Non-RT RIC 215 may monitor long-term trends and patterns for performance and employ AI/ML models to perform corrective actions through the SMO Framework 205 (such as reconfiguration via O1) or via creation of RAN management policies (such as A1 policies).

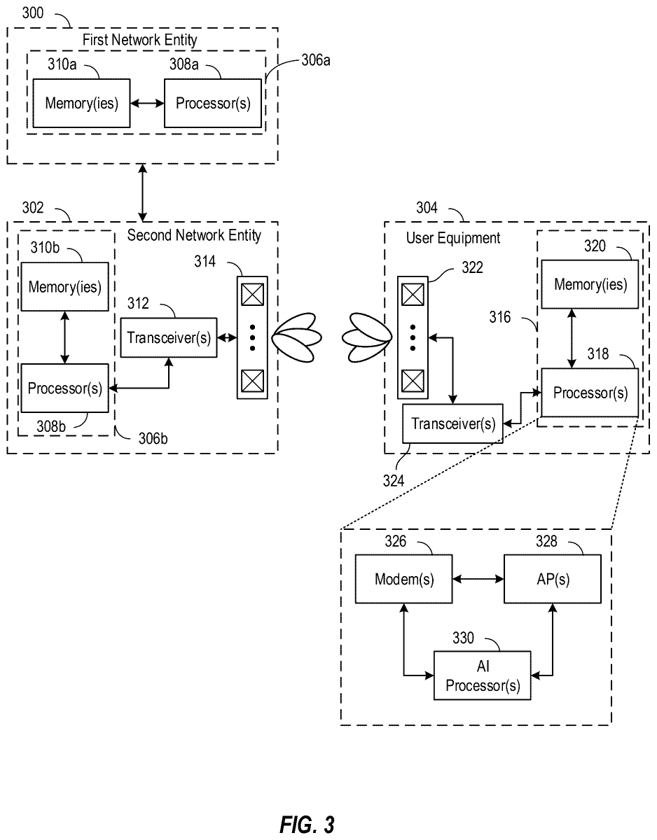

FIG. 3 depicts aspects of network entities 300 and 302 and a UE 304.

FIG. 3 includes a first network entity 300 and a second network entity 302. In some examples, first network entity 300 may be an example of a CU 210 or a DU 230. In some examples, second network entity 302 may be an example of a DU 230 or an RU 240. First network entity 300 and second network entity 302 may communicate with one another via a communications link, such as a midhaul link. In some examples, first network entity 300 and second network entity 302 may be implemented at a same BS (e.g., BS 102). For example, first network entity 300 and second network entity 302 may be co-located. In some other examples, first network entity 300 may be implemented separately from second network entity 302. For example, first network entity 300 may be implemented as a function (e.g., one or more processes) running on a server, such as in a cloud (e.g., a public or private cloud). As another example, first network entity 300 may be implemented as a virtual computing instance (e.g., virtual machine, container, etc.) or as a physical server.

First network entity 300 and second network entity 302 each include a processing system 306, illustrated as “processing system 306a” at first network entity 300 and “processing system 306b” at second network entity 302. For example, first network entity 300 and second network entity 302 may include one or more chips, system-on-chips (SoCs), system-in-packages (SiPs), chipsets, packages, or devices that individually or collectively constitute or comprise a processing system 306. A processing system 306 includes one or more processors 308 (illustrated as “processor(s) 308a” and “processor(s) 308b”) and one or more memories 310 (illustrated as “memory(ies) 310a” and “memory(ies) 310b”) coupled to the one or more processors 308. The one or more processors 308 may include one or multiple processors, microprocessors, processing units (such as central processing units (CPUs), graphics processing units (GPUs), neural processing units (NPUs) (also referred to as neural network processors or deep learning processors (DLPs)) and/or digital signal processors (DSPs)), processing blocks, application-specific integrated circuits (ASIC), programmable logic devices (PLDs) (such as field programmable gate arrays (FPGAs)), or other discrete gate or transistor logic or circuitry (any one or more of which may be generally referred to herein individually as a “processor” or collectively as “the processor” or “the processor circuitry”). One or more of the processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set. In some other examples, each of a group of processors may be configurable or configured to perform a same set of functions.

In some aspects, the processing system 306 may perform processing (such as digital signal processing) of data, control information, or signals received or transmitted by a network entity. For example, the processing system 306 may include a coder, a decoder, a multiplexer, a demultiplexer, a transmit MIMO processor, a transmit processor, a receive processor, a receive MIMO detector, an automatic gain control component, or the like.

The one or more memories 310 may include one or more memory devices, memory blocks, memory elements or other discrete gate or transistor logic or circuitry, each of which may include tangible storage media such as random-access memory (RAM) or read-only memory (ROM), or combinations thereof (all of which may be generally referred to herein individually as “memories” or collectively as “the memory” or “the memory circuitry”). The one or more memories 310 may store data and program code for first network entity 300 and/or second network entity 302.

As further shown, second network entity 302 includes one or more transceivers 312 (illustrated as “transceiver(s) 312”). The one or more transceivers 312 may perform processing related to implementing physical layer (e.g., radio, air interface) communication with other devices such as UE 304. The one or more transceivers 312 may include one or more radio frequency (RF) components, such as an RF transceiver, a front-end module (e.g., an RF front-end (RFFE)), or the like. For example, the one or more transceivers 312 may include a transmit path (also referred to as a transmit chain), a receive path (also referred to as a receive chain), and/or an interface with one or more antennas 314.

The one or more antennas 314 may perform wireless transmission and reception of signals. The one or more antennas 314 may include, or may be included within, one or more antenna panels, one or more antenna groups, one or more sets of antenna elements, or one or more antenna arrays, among other examples. An antenna panel, an antenna group, a set of antenna elements, or an antenna array may include one or more antenna elements (within a single housing or multiple housings), a set of coplanar antenna elements, a set of non-coplanar antenna elements, or one or more antenna elements coupled with one or more transmission or reception components, such as one or more components of FIG. 3.

UE 304 may be an example of UE 104. As shown, UE 304 includes a processing system 316. For example, UE 304 may include one or more chips, SoCs, SiPs, chipsets, packages, or devices that individually or collectively constitute or comprise a processing system 316. A processing system 316 includes one or more processors 318, and one or more memories 320 coupled to the one or more processors 318. Further, UE 304 includes one or more antennas 322, one or more transceivers 324, and/or other components that enable wireless transmission and reception of data.

The one or more processors 318 may include one or multiple processors, microprocessors, processing units (such as CPUs, GPUs, NPUs (also referred to as neural network processors or DLPs) and/or DSPs), processing blocks, ASICs, PLDs (such as FPGAs), or other discrete gate or transistor logic or circuitry (any one or more of which may be generally referred to herein individually as a “processor” or collectively as “the processor” or “the processor circuitry”). One or more of the processors may be individually or collectively configurable or configured to perform various functions or operations described herein. In some aspects, the processing system 316 may perform processing (such as digital signal processing) of data, control information, or signals received or transmitted by a network entity. For example, the processing system 316 may include a coder, a decoder, a multiplexer, a demultiplexer, a transmit MIMO processor, a transmit processor, a receive processor, a receive MIMO detector, an automatic gain control component, or the like.

As shown, in some examples, the one or more processors 318 may include one or more modems 326, one or more application processors (APs) 328, one or more AI processors 330, a combination thereof, and/or another form of processor.

The one or more modems 326 may include a digital signal processor that converts information into a waveform for analog signal transmission (e.g., via modulation) and/or converts the waveform of a received signal into information (e.g., via demodulation). The one or more modems 326 may process information or waveforms in connection with signal transmission or reception. For example, the one or more modems 326 may include a coder, a decoder, a multiplexer, a demultiplexer, a transmit MIMO processor, a transmit processor, a receive processor, a receive MIMO detector, an automatic gain control component, or the like.

The one or more APs 328 may perform processing relating to an operating system and/or a higher layer application of the UE 304. For example, the one or more APs 328 may provide a higher-level operating system (HLOS), software, audio or video processing, graphics processing, or the like. In some examples, the one or more APs 328 may be a data source (e.g., for transmissions) or a data sink (e.g., for receptions).

The one or more transceivers 324 may perform processing related to implementing physical layer (e.g., radio, air interface) communication with other devices such as other UEs 304 or second network entity 302. The one or more transceivers 324 may include one or more RF components, such as an RF transceiver, a front-end module (e.g., an RFFE), or the like. For example, the one or more transceivers 324 may include a transmit path (also referred to as a transmit chain), a receive path (also referred to as a receive chain), and/or an interface with one or more antennas 322.

The one or more antennas 322 may perform wireless transmission and reception of signals. The one or more antennas 322 may include, or may be included within, one or more antenna panels, one or more antenna groups, one or more sets of antenna elements, or one or more antenna arrays, among other examples. An antenna panel, an antenna group, a set of antenna elements, or an antenna array may include one or more antenna elements (within a single housing or multiple housings), a set of coplanar antenna elements, a set of non-coplanar antenna elements, or one or more antenna elements coupled with one or more transmission or reception components, such as one or more components of FIG. 3.

For an example downlink transmission by second network entity 302, the processing system 306 (e.g., a transmit processor) may receive data and/or control information. The control information may be for the physical broadcast channel (PBCH), physical control format indicator channel (PCFICH), physical hybrid automatic repeat request (HARQ) indicator channel (PHICH), physical downlink control channel (PDCCH), group common PDCCH (GC PDCCH), and/or others. The data may be for the physical downlink shared channel (PDSCH), in some examples.

The processing system 306 (e.g., a transmit processor) may process (e.g., encode and symbol map) the data and control information to obtain data symbols and control symbols, respectively. The processing system 306 may also generate reference symbols, such as for the primary synchronization signal (PSS), secondary synchronization signal (SSS), PBCH demodulation reference signal (DMRS), or channel state information reference signal (CSI-RS).

The processing system 306 (e.g., a TX MIMO processor) may perform spatial processing (e.g., precoding) on the data symbols, the control symbols, and/or the reference symbols, if applicable, and may provide output symbol streams to one or more modulators of the processing system 306. The one or more modulators may process one or more respective output symbol streams to obtain an output sample stream. The one or more transceivers 312 may process (e.g., convert to analog, amplify, filter, and upconvert) the output sample stream to obtain a downlink signal. Second network entity 302 may transmit the downlink signal via the one or more antennas 314.

In order to receive the downlink transmission at UE 304 (or a sidelink transmission from another UE), the one or more antennas 322 may receive the downlink signal and may provide received signals to the one or more transceivers 324. The one or more transceivers 324 may condition (e.g., filter, amplify, downconvert, and digitize) the received signals to obtain input samples. The one or more transceivers 324 and/or the processing system 316 may further process the input samples to obtain received symbols.

The processing system 316 (e.g., modem 326, an RX MIMO detector) may obtain the received symbols, perform MIMO detection on the received symbols if applicable, and provide detected symbols. The processing system 316 (e.g., a modem 326, a receive processor) may process (e.g., de-interleave and decode) the detected symbols. The processing system 316 may provide decoded data for the UE 304 (e.g., to an AP 328) and/or decoded control information (e.g., to a controller/processor of the processing system 316).

For an example uplink transmission or a sidelink transmission from UE 304, the processing system 316 (e.g., modem 326, a transmit processor) may receive and process data and/or control information to obtain a set of symbols for transmission. The data may be for the physical uplink shared channel (PUSCH), and may be received from a data source such as the AP 328. The control information may be for the physical uplink control channel (PUCCH), and may be received, for example, from a controller/processor of the processing system 316. The processing system 316 (e.g., a modem 326, the transmit processor) may also generate reference symbols for a reference signal (e.g., for a sounding reference signal (SRS), a demodulation reference signal, a phase tracking reference signal, or the like). In some examples, the symbols and/or reference signals may be precoded by the processing system 316 (e.g., modem 326, a TX MIMO processor), further processed by the one or more transceivers 324 (e.g., for SC-FDM), and transmitted to second network entity 302.

At second network entity 302, the uplink signals from UE 304 may be received by the one or more antennas 314, conditioned by the one or more transceivers 312 (e.g., filtered, amplified, downconverted, and digitized), detected (e.g., by the processing system 306b such as a modem and/or an RX MIMO detector), and further processed by the processing system 306b (e.g., a modem and/or a receive processor) to obtain decoded data and control information sent by UE 304. The processing system 306b may provide the decoded data and the decoded control information (such as to a controller/processor of the processing system 306b, an AP, first network entity 300, or another entity).

In various aspects, a wireless communication device, such as first network entity 300, second network entity 302, BS 102, UE 104, or UE 304 may be described as sending, transmitting, obtaining, or receiving various types of data associated with the methods described herein. In these contexts, “transmitting” or “sending” may refer to various mechanisms of outputting data, such as outputting data from a processing system, one or more memories, one or more transceivers, one or more antennas, and/or other aspects described herein. For example, “sending” or “transmitting” by a device may include sending (such as wirelessly, via a wired connection, or both) to a recipient directly or via another device. As another example, “sending” or “transmitting” may include sending internally to a device (such as the UE 304, first network entity 300, or second network entity 302) by a process to memory. “Receiving” or “obtaining” may refer to various mechanisms of obtaining data, such as obtaining data from the processing system, one or more memories, one or more transceivers, one or more antennas, and/or other aspects described herein. For example, “receiving” or “obtaining” by a device may include obtaining (such as wirelessly, via a wired connection, or both) from a recipient directly or via another device. As another example, “receiving” or “obtaining” may include obtaining internally to a device (such as the UE 304, first network entity 300, or second network entity 302) by a process from memory. As used herein, “communicating” by a device may include sending, obtaining, receiving, and/or transmitting a communication. “Communicating” can refer to communication with another device or internal communication of the device.

In various aspects, the processing system 306 or the processing system 316 may include one or more AI processors (such as AI processor 330 of the processing system 316). An AI processor may perform AI processing. The AI processor may include AI accelerator hardware or circuitry such as one or more neural processing units (NPUs), one or more neural network processors, one or more tensor processors, one or more deep learning processors, etc. As an example, the AI processor may perform AI-based beam management, AI-based channel state feedback (CSF), AI-based antenna tuning, and/or AI-based positioning (e.g., non-line of sight positioning prediction). In some cases, at the UE 104, the AI processor may process feedback generated by the UE 304 (e.g., CSF) using hardware accelerated AI inferences and/or AI training. In some cases, at the second network entity 302, the AI processor may decode compressed CSF from the UE 304, for example, using a hardware accelerated AI inference associated with the CSF. In certain cases, the AI processor may perform certain RAN-based functions including, for example, network planning, network performance management, energy-efficient network operations, etc.

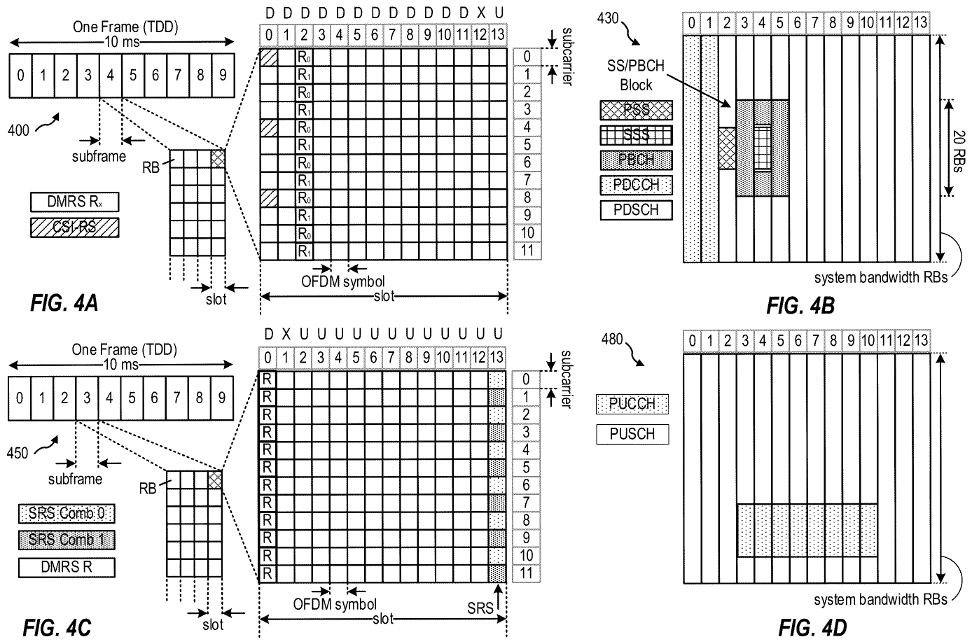

FIGS. 4A, 4B, 4C, and 4D depict aspects of data structures for a wireless communications network, such as wireless communications network 100 of FIG. 1.

FIG. 4A is a diagram 400 illustrating an example of a first subframe within a 5G (e.g., 5G NR) frame structure, FIG. 4B is a diagram 430 illustrating an example of DL channels within a 5G subframe, FIG. 4C is a diagram 450 illustrating an example of a second subframe within a 5G frame structure, and FIG. 4D is a diagram 480 illustrating an example of UL channels within a 5G subframe.

Wireless communications systems may utilize orthogonal frequency division multiplexing (OFDM) with a cyclic prefix (CP) on the uplink and downlink. Such systems may also support half-duplex operation using time division duplexing (TDD). OFDM and single-carrier frequency division multiplexing (SC-FDM) partition the system bandwidth (e.g., as depicted in FIGS. 4B and 4D) into multiple orthogonal subcarriers. One or more subcarriers may be modulated with data. Modulation symbols may be sent in the frequency domain with OFDM and/or in the time domain with SC-FDM.

In some examples, a wireless communications frame structure may be implemented using frequency division duplexing (FDD). In FDD, some subcarriers may be configured for DL communication, and other subcarriers (which may overlap in time with the DL subcarriers) may be configured for UL communication. In some other examples, wireless communications frame structures may be implemented using time division duplexing (TDD). In TDD, for a particular set of subcarriers, some subframes are configured for DL communication and other subframes are configured for UL communication.

In FIGS. 4A and 4C, the wireless communications frame structure is implemented using TDD. “D” indicates DL time resources, “U” indicates UL time resources, and “X” indicates flexible time resources for use or later reconfiguration for either DL or UL communication. UEs may be configured with a slot format through a received slot format indicator (SFI) (dynamically through DL control information (DCI), or semi-statically/statically through radio resource control (RRC) signaling). In the depicted examples, a 10 ms frame is divided into 10 equally sized 1 ms subframes. Each subframe may include one or more time slots. In some examples, each slot may include 12 or 14 symbols, depending on the cyclic prefix (CP) type (e.g., 12 symbols per slot for an extended CP or 14 symbols per slot for a normal CP). Subframes may also include mini-slots, which generally have fewer symbols than an entire slot. Other wireless communications technologies may have a different frame structure and/or different channels.

In certain aspects, the number of slots within a subframe (e.g., a slot duration in a subframe) is based on a numerology. A numerology may define a frequency domain subcarrier spacing and symbol duration, and may be configured for a given bandwidth part, carrier, cell, or network entity. In certain aspects, given a numerology μ, there are 24 slots per subframe. Thus, numerologies (μ) 0 to 6 may allow for 1, 2, 4, 8, 16, 32, and 64 slots, respectively, per subframe. In some cases, an extended CP (e.g., 12 symbols per slot) may be used with a specific numerology, such as numerology μ=2 allowing for 4 slots per subframe. The subcarrier spacing and symbol length/duration are a function of the numerology. The subcarrier spacing may be equal to 2^{μ}×15 kHz. As an example, the numerology μ=0 corresponds to a subcarrier spacing of 15 kHz, and the numerology μ=6 corresponds to a subcarrier spacing of 960 kHz. The symbol length/duration is inversely related to the subcarrier spacing. FIGS. 4A, 4B, 4C, and 4D provide an example of a slot format having 14 symbols per slot (e.g., a normal CP) and a numerology μ=2 with 4 slots per subframe. In such a case, the slot duration is 0.25 ms, the subcarrier spacing is 60 kHz, and the symbol duration is approximately 16.67 μs.

As depicted in FIGS. 4A, 4B, 4C, and 4D, a resource grid may be used to represent the frame structure. Each time slot includes a resource block (RB) (also referred to as a physical RB (PRB)) that extends across, for example, 12 consecutive subcarriers. The resource grid is divided into multiple resource elements (REs). An RE may include a single subcarrier in the frequency domain and a single symbol in the time domain. The number of bits carried by each RE depends on the modulation scheme including, for example, quadrature phase shift keying (QPSK) or quadrature amplitude modulation (QAM).

As illustrated in FIG. 4A, some of the REs carry reference (pilot) signals (shown as “RS”) for a UE (e.g., UE 104 of FIGS. 1 and 3). The RS may include a demodulation RS (DMRS) and/or a channel state information reference signals (CSI-RS) for channel estimation at the UE. The RS may additionally or alternatively include a beam measurement RS (BRS), a beam refinement RS (BRRS), and/or a phase tracking RS (PT-RS).

FIG. 4B illustrates an example of various DL channels within a subframe of a frame. The physical downlink control channel (PDCCH) carries DCI within one or more control channel elements (CCEs), each CCE including, for example, nine RE groups (REGs), each REG including, for example, four consecutive REs in an OFDM symbol.

A primary synchronization signal (PSS) may be within symbol 2 of particular subframes of a frame. The PSS is used by a UE (e.g., 104 of FIGS. 1 and 3) to determine subframe/symbol timing and a physical layer identity.

A secondary synchronization signal (SSS) may be within symbol 4 of particular subframes of a frame. The SSS is used by a UE to determine a physical layer cell identity group number and radio frame timing.

Based on the physical layer identity and the physical layer cell identity group number, the UE can determine a physical cell identifier (PCI). Based on the PCI, the UE can determine the locations of the aforementioned DMRS. The physical broadcast channel (PBCH), which carries a master information block (MIB), may be logically grouped with the PSS and SSS to form a synchronization signal (SS)/PBCH block (SSB), and in some cases, referred to as a synchronization signal block (SSB). The MIB provides a number of RBs in the system bandwidth and a system frame number (SFN). The physical downlink shared channel (PDSCH) carries user data, broadcast system information not transmitted through the PBCH such as system information blocks (SIBs), and/or paging messages.

As illustrated in FIG. 4C, some of the REs carry DMRS (indicated as “R” for one particular configuration, but other DMRS configurations are possible) for channel estimation at the base station. The UE may transmit DMRS for the PUCCH and DMRS for the PUSCH. The PUSCH DMRS may be transmitted, for example, in the first one or two symbols of the PUSCH. The PUCCH DMRS may be transmitted in different configurations depending on whether short or long PUCCHs are transmitted and depending on the particular PUCCH format used. UE 104 may transmit sounding reference signals (SRS). The SRS may be transmitted, for example, in the last symbol of a subframe. The SRS may have a comb structure, and a UE may transmit SRS on one of the combs. The SRS may be used by a base station for channel quality estimation to enable frequency-dependent scheduling on the UL.

FIG. 4D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and HARQ ACK/NACK feedback. The PUSCH carries data, and may additionally be used to carry a buffer status report (BSR), a power headroom report (PHR), and/or UCI.

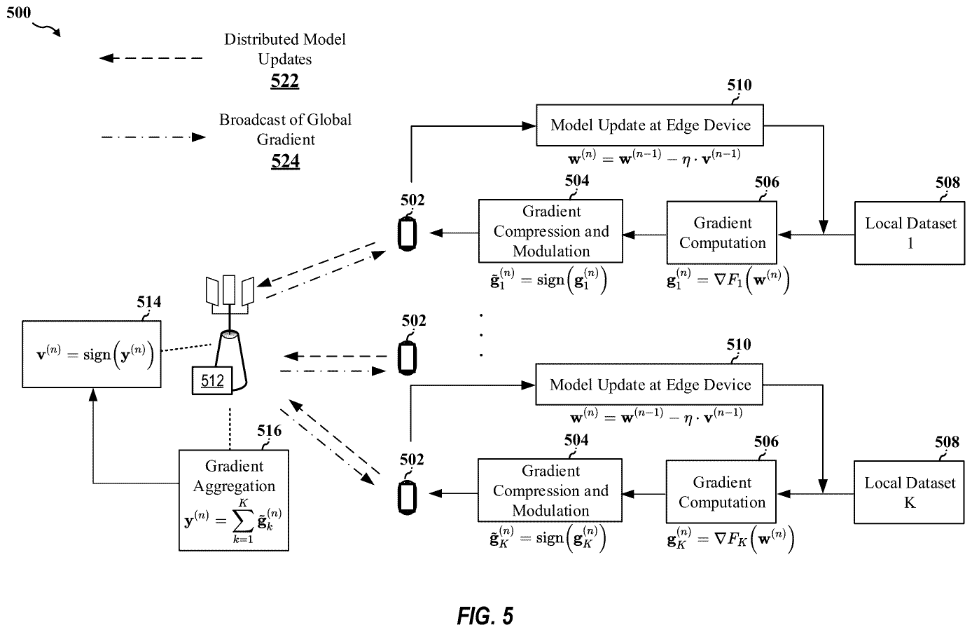

FIG. 5 is a diagram of an example environment 500 associated with federated learning according to one or more aspects. The parameter server 512 (also referred to as an edge server) may correspond to the BS 102, the first network entity 300, the second network entity 302, or an element of a disaggregated RAN described with regard to FIG. 2. The edge device 502 may correspond to the UE 104 or 304. An edge device 502 may be referred to herein as a node, and a parameter server 512 may be referred to herein as a network entity.

Federated learning is a technique that may enable users (e.g., UEs or edge devices) to train a ML model (e.g., a neural network) in a collaborative and distributed fashion using users' local datasets at edge devices (e.g., nodes). Specifically, in each round, the parameter server 512 may select a number of edge devices 502, and may transmit 524 a copy of the global ML model (e.g., the copy may include the parameters (weights) or a gradient set of the global ML model) to each of the selected edge devices 502. Then, at 506, each edge device 502 may compute updated local model parameters or gradients (or gradient set elements) of the ML model based on a local copy of the ML model (which may be referred to as the local ML model hereinafter) that is updated, at 510, with the local dataset 508 at the edge device 502. At 504, each edge device 502 may compress and/or modulate the computed local gradients (or gradient set elements) in preparation for transmission. Next, each edge device 502 may feedback, at 522, the corresponding update including the updated local model parameters or the local gradient set elements to the parameter server 512. Thereafter, the parameter server 512 may aggregate, at 516, all the updates 522 from the edge devices 502, and may update, at 514, the global ML model based on the aggregated updates. For the next iteration/round, the parameter server 512 may transmit a copy of the updated global machine model (e.g., parameters (weights) or a global gradient set) to selected edge devices 502, and the edge devices 502 may perform again similar operations as described above. The process may be repeated for a number of times corresponding to a number of iterations/rounds until the global ML model converges (e.g., until the global model update may no longer produce any non-negligible changes to the global ML model).

Federated learning may be associated with the advantage of keeping user data (e.g., local dataset 508) private at edge devices 502 based on the distributed optimization framework (i.e., the user data itself may not be transmitted to the parameter server 512).

In one or more configurations, the federated learning, in particular, the gradient update and aggregation, may be performed using a “signSGD” approach. For the federated learning, in communication round n, the k-th UE may calculate the gradient,

$${w}_{k}^{( n )} ,$$

based on a subset of the local dataset of the k-th UE may calculate the gradient, the network (e.g., the parameter server). For the OTA federated learning, multiple nodes may share the same resources for transmitting their gradients. In particular, each UE may transmit

$$\frac{{w}_{k}^{( n )}}{{h}_{k}^{( n )}} , where {h}_{k}^{( n )}$$

may be the channel coefficient of the resource (referred to as channel pre-compensation). Of course, there may be different schemes for the channel pre-compensation at the UE (e.g., zero forcing, minimum mean square error (MMSE), etc.).

In one or more configurations, the received signal at the parameter server at the n-th communication round may be given as follows:

$${r}^{( n )} = {\sum }_{k = 1}^{K} {h}_{k}^{( n )} \frac{{w}_{k}^{( n )}}{{h}_{k}^{( n )}} = {\sum }_{k = 1}^{K} {w}_{k}^{( n )} .$$

For the OTA federated learning, gradient combining may be performed OTA utilizing the superposition property of the wireless channel. Due to the channel pre-compensation, the gradients may be coherently combined. The network (e.g., the parameter server) may be interested just in the sum of the local gradients. Hence, there may be no need to resolve the interference between the gradients transmitted by the different nodes. In fact, the interference may be utilized to accumulate the gradients.

In one or more configurations, instead of sending the actual gradients, the nodes may implement the “signSGD” approach. In particular, with the “signSGD” approach, a node may send just the sign of the gradient instead of the actual gradient. The “signSGD” approach may be associated with efficient compression of the gradient transmission. Accordingly, use of the “signSGD” approach may lead to reduction of transmission overhead while maintaining a high convergence rate. It should be noted that some aspects described herein are implemented with signaling o the actual gradient instead of just the sign of the gradient.

When performing the updating using the sign of the gradient, in one or more configurations, the gradient combining for the federated learning may be performed in a non-coherent fashion. In particular, all UEs may simultaneously transmit the signs of respective gradients using a non-coherent orthogonal modulation scheme using two resources: l⁺ and l⁻. The transmitted symbols t_{k,l}_{⁺} and t_{k,1}_{^{−}} may be given as follows:

$$\begin{matrix}{t}_{k , {l}^{+}} = \{ \begin{matrix}\sqrt{{p}_{k}} \times {s}_{k , i}^{( n )} , & when {w}_{k , i}^{( n )} \geq 0 \\ 0 , & when {w}_{k , i}^{( n )} < 0\end{matrix} , \\ {t}_{k , {l}^{-}} = \{ \begin{matrix}0 , & when {w}_{k , i}^{( n )} \geq 0 \\ \sqrt{{p}_{k}} \times {s}_{k , i}^{( n )} , & when {w}_{k , i}^{( n )} < 0\end{matrix} , \\ where {s}_{k , i}^{( n )}\end{matrix}$$

may be a (pseudo-)random symbol on a unit circle, and may be independent (different) across resources and UEs, pk may be the power of the transmitted symbol, i may represent the gradient index, and l may represent the time-frequency resource index.

Accordingly, at the network (e.g., the parameter server), the received superimposed (superposed) compressed gradients on the pair of resources may be given as follows:

$$\begin{matrix}{r}_{{l}^{+}}^{( n )} = {\sum }_{∀ k} \sqrt{{p}_{k}} {h}_{k , {l}^{+}}^{( n )} {s}_{k , i}^{( n )} + {n}_{{l}^{+}}^{( n )} , \\ {r}_{{l}^{-}}^{( n )} = {\sum }_{∀ k} \sqrt{{P}_{k}} {h}_{k , {l}^{-}}^{( n )} {s}_{k , i}^{( n )} + {n}_{{l}^{-}}^{( n )} .\end{matrix}$$

In some configurations, the channel phase may be random. Further, it may be assumed that the UEs may not have the channel phase information to perform channel pre-compensation.

In one or more configurations, the received power on both resources l⁺ and l⁻ may be accumulated. The average power of the received signals on the two resources may be given as follows:

$$\begin{matrix}E [ {r}_{{l}^{+}}^{( n )} {r}_{{l}^{+}}^{( n ) +} ] = {\sum }_{∀ {k}_{∈ {K}^{+}} ( n )} {p}_{k} + {σ}^{2} , \\ E [ {r}_{{l}^{-}}^{( n )} {r}_{{l}^{-}}^{( n ) +} ] = {\sum }_{∀ {k}_{∈ {K}^{-}} ( n )} {p}_{k} + {σ}^{2}\end{matrix}$$

where K⁺^{⁽ⁿ⁾} and K⁻^{⁽ⁿ⁾} may be the set (list) of UEs voting for positive and negative gradients, respectively, in the n-th communication round, and σ² may be the noise power. The small scale fading channel coefficients

$${h}_{k , {l}^{+}}^{( n )} {and}_{k , {l}^{-}}^{( n )}$$

may be averaged out, since

$$E \{ {\vert {h}_{k , {l}^{+}}^{( n )} \vert}^{2} \} = E \{ {\vert {h}_{k , {l}^{-}}^{( n )} \vert}^{2} \} = 1.$$

In one or more configurations, the same gradient may be transmitted over multiple resources to achieve sufficient channel averaging.

Next, the parameter server 512 may update the global training parameters. For example, the parameter server 512 may update the global training parameters using actual gradients signaled by the edge devices 502. As another example, the parameter server 512 may update the global training parameters using sign indications signaled by the edge devices 502. Thereafter, the parameter server may share the updated global training parameters (e.g., weights) with the UEs.

In one or more configurations, the network (e.g., the parameter server) may be configured to enable the non-coherent combining of the local gradients without channel pre-compensation. To that end, the network may configure UEs participating in the federated learning (training) to send the local gradient updates (which may be referred to simply as gradients) using a non-coherent orthogonal modulation scheme. An example non-coherent orthogonal modulation schemes have been described in detail above. In particular, the network may configure the UEs to transmit indications of the signs of the local gradients using the “signSGD” approach, instead of sending the actual gradients. In one or more configurations, the network may configure the UEs with the non-coherent orthogonal modulation scheme via one or more of an RRC message, a MAC-control element (MAC-CE), a system information (SI) message, or a DCI message.

As part of a federated learning process for an ML model, such as an artificial neural network, parameters affecting the functioning of artificial neurons and layers of the ML model may be adjusted. For example, backpropagation techniques may be used to train the ML model by iteratively adjusting weights and/or biases of certain artificial neurons associated with errors between a predicted output of the model and a desired output that may be known or otherwise deemed acceptable. Backpropagation may include a forward pass, a loss function, a backward pass, and a parameter update that may be performed in training iteration. The process may be repeated for a certain number of iterations for each set of training data until the weights of the artificial neurons/layers are adequately tuned.

Backpropagation techniques associated with a loss function may measure how well a model is able to predict a desired output for a given input. An optimization algorithm may be used during a training process to adjust weights and/or biases to reduce or minimize the loss function which should improve the performance of the model. There are a variety of optimization algorithms that may be used along with backpropagation techniques or other training techniques. Some initial examples include a gradient descent based optimization algorithm and a stochastic gradient descent based optimization algorithm. A stochastic gradient descent (or ascent) technique may be used to adjust weights/biases in order to minimize or otherwise reduce a loss function. A mini-batch gradient descent technique, which is a variant of gradient descent, may involve updating weights/biases using a small batch of training data rather than the entire dataset. A momentum technique may accelerate an optimization process by adding a momentum term to update or otherwise affect certain weights/biases.

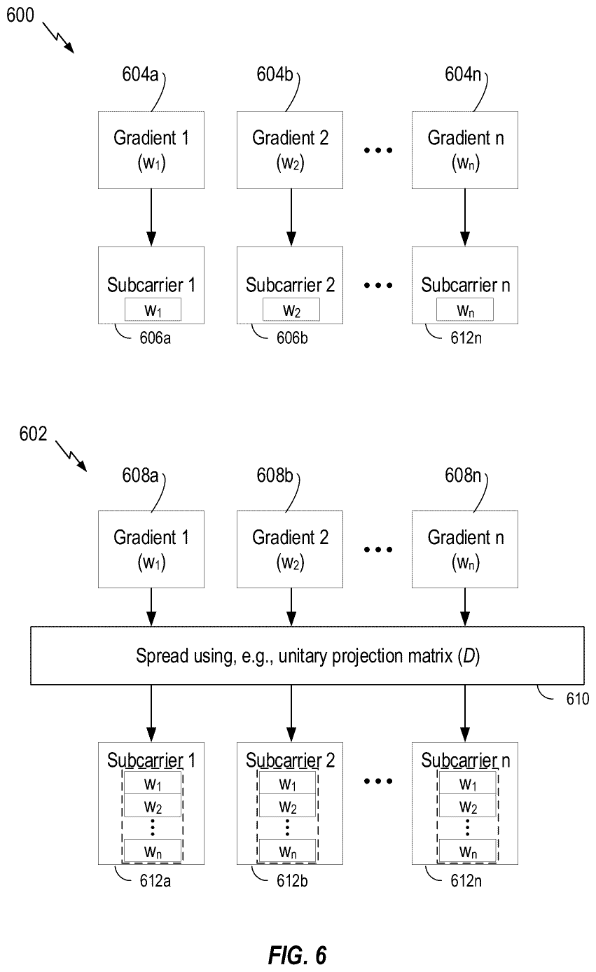

FIG. 6 is a diagram illustrating an example 600 of gradient signaling without projection, and an example 602 of gradient signaling with projection onto a plurality of subcarriers.

As shown, in example 600, each gradient indication 604 (denoted w; for i between 1 and n) is transmitted on a respective subcarrier 606. OTA aggregation may provide for a particular gradient indication wⱼ, as transmitted by multiple nodes (e.g., UE 104, UE 304, edge device 502), to be received as

$${w}_{j} = {\sum }_{n} {h}_{n} ( {h}_{n}^{- 1} {w}_{j , n} ) .$$

Note that pre-equalization is applied here, as indicated by the application of the inverse channel matrix to the nth node's gradient indication w_{j,n}. In this approach, dynamically changing channel conditions may lead to a given gradient indication having a distorted received power, degrading accuracy of gradient signaling.

As shown, in example 602, each gradient indication 608 (denoted wᵢ for i between 1 and n) is projected, using a unitary projection matrix 610, such that each gradient indication 608 is transmitted on a plurality of subcarriers 612. The unitary projection matrix 610 may include, for example, a unitary matrix. Examples of unitary matrixes include a discrete Fourier transform (DFT) matrix or a Hadamard matrix.

A receiver (not illustrated) may receive a signal comprising the plurality of subcarriers 612 (including the gradient indications 608). The receiver may use an inverse of the unitary projection matrix 610 (denoted D^{H}) to obtain the gradient indications 608. For example, the receiver may obtain the gradient indications 608 as

$$W = {D}^{H} {\sum }_{n} {H}_{n , t 1} ( {H}_{n , t 0}^{- 1} {Dw}_{n} ) + {D}^{H} Z ,$$

where H_{n,t} is a diagonal matrix whose main diagonal jth element is h_{n,j,t}, respectively, W is a vector of the resulting gradient indications, Z is a noise vector, and wₙ is a vector concatenating all w_{j,n}. Thus, the transmitter may transform gradient indications wn using the unitary projection matrix 610 such that the gradient indications 608 are transmitted on a plurality of subcarriers 612. The transmitter may also perform pre-equalization using H⁻¹. The receiver may receive H⁻¹Dwₙ+Z, and may apply the inverse of the unitary projection matrix 610 (D^{H}) to obtain wₙ.

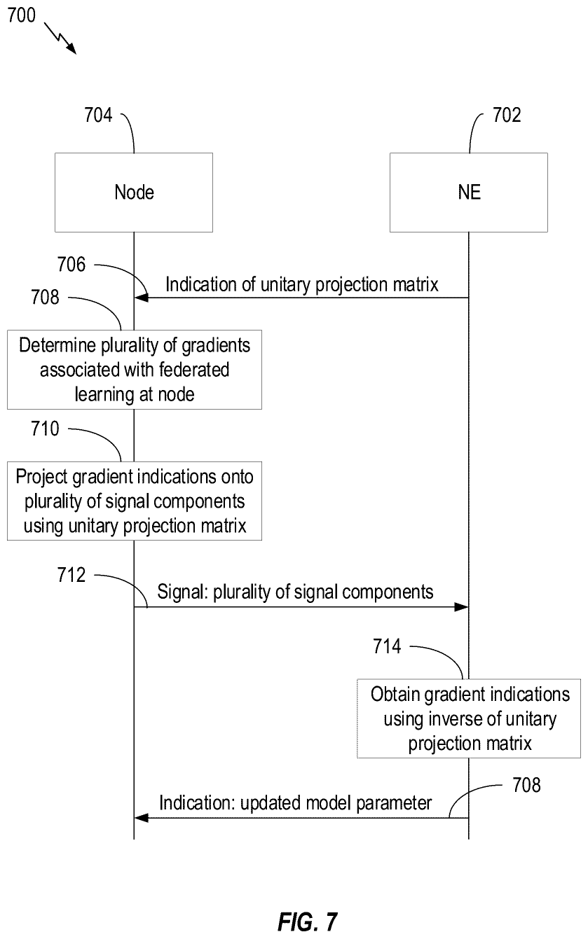

FIG. 7 is a diagram illustrating an example 700 of signaling for projection of gradient indications onto a plurality of subcarriers. Example 700 includes a node 704 (e.g., UE 104, UE 304, edge device 502) and a network entity 702 (e.g., BS 102, first network entity 300, second network entity 302, an element of a disaggregated RAN of FIG. 2, or a parameter server 512).

Example 700 is described with regard to a single node 704 for clarity. However, it should be understood that operations described as being performed by the node (including transmission operations, reception operations, and identification operations) may be performed by each of a set of nodes that include the node 704.

As shown at 706, in some aspects, the network entity 702 may transmit, and the node 704 may receive, an indication of a unitary projection matrix (e.g., unitary projection matrix 610). For example, the indication may indicate to use a unitary projection matrix to project a plurality of gradient indications onto a plurality of subcarriers as described with regard to FIG. 6. As another example, the indication may indicate a particular unitary projection matrix (e.g., may explicitly define the particular unitary projection matrix or may include an index that indicates the particular unitary projection matrix). As another example, the indication may indicate a type of unitary projection matrix (e.g., DFT, Hadamard, etc.). A DFT matrix is a matrix whose [n,k]th element is defined as exp(−i*2*pi*n*k/N), where N is the size of the DFT matrix. The DFT matrix may be scaled by 1/sqrt (N). The Hadamard matrix may be built recursively, where a matrix of size 2k is built from a matrix of size K as H₂ₖ=[Hₖ Hₖ; Hₖ−Hₖ]. In some aspects, the indication of the unitary projection matrix may be specific to the network entity 702. For example, different network entities 702 may be configured with different unitary projection matrixes (e.g., a first network entity 702 may be configured with a first unitary projection matrix, a second network entity 702 may be configured with a second unitary projection matrix, and so on). The node 704 may use the indicated unitary projection matrix to perform projection of gradients, as described in more detail elsewhere herein. For example, a first set of nodes communicating with a first network entity 702 (e.g., as part of a first federated learning) may use a first unitary projection matrix specific to the first network entity 702, and a second set of nodes communicating with a second network entity 702 (e.g., as part of a second federated learning) may use a second unitary projection matrix specific to the second network entity 702. The first unitary projection matrix may be different than the second unitary projection matrix. By using different unitary projection matrixes for different network entities 702, interference between signaling of gradient indications is reduced.

In some aspects, the unitary projection matrix is specific to a layer. For example, the unitary projection matrix may be specific to projection of gradient indications for a MIMO layer, and different unitary projection matrixes may be used for different MIMO layers. In some other aspects, the unitary projection matrix may be used for multiple layers, such as multiple MIMO layers. In such examples, for N_{layers} number of layers and N_{SC} number of subcarriers, the unitary projection matrix may have a size of (N_{SC}*N_{layers})*(N_{SC}*N_{layers}).

As shown at 708, the node 704 may determine a plurality of gradients associated with federated learning at the node 704. In some aspects, the node 704 may determine the plurality of gradients using a forward-pass (based on a loss function) and backward-pass (e.g., backpropagation) approach. The node 704 may determine a gradient indication for a gradient. As one example, a gradient indication may indicate whether a gradient has a positive sign (and should thus be transmitted on a first resource) or a negative sign (and should thus be transmitted on a second resource). As another example, the gradient indication may explicitly identify the gradient.

As shown at 710, the node 704 may project the one or more gradient indications onto a plurality of signal components. For example, each signal component may correspond to (e.g., be transmitted on) a respective subcarrier of a plurality of subcarriers. For example, the node 704 may perform matrix multiplication of the unitary projection matrix, D, and a vector or matrix representing the one or more gradient indications, w, as described in connection with FIG. 6. Thus, each gradient indication is projected onto all signal components (for transmission on all subcarriers) of the plurality of signal components. In some aspects, the unitary projection matrix is defined in a wireless communication specification. In some other aspects, as described above, the network entity 702 may transmit an indication of the unitary projection matrix to the node 704.

In some aspects, the node 704 may perform the projection dynamically. For example, the network entity 702 may activate or deactivate the projection based on transmitting an indication, to the node 704, to activate or deactivate the indication. The node 704 may activate or deactivate the projection in accordance with the indication. In some aspects, the node 704 may perform projection (and/or the network entity 702 may activate projection) in accordance based on a time between channel estimation and transmission. For example, since pre-equalization of the gradients is derived from the channel estimation, a larger time between channel estimation and transmission may lead to more unpredictable performance of particular subcarriers. The network entity 702 may activate, or the node 704 may perform, projection when the time satisfies a threshold (e.g., is longer than the threshold, is longer than or equal to the threshold).

As shown at 712, the node 704 may transmit, and the network entity 702 may receive, a signal comprising the plurality of signal components. For example, the node 704 may transmit the signal on subcarriers 612 (e.g., subcarriers 1 through n) of example 600.

As shown at 714, the network entity 702 may use an inverse of the unitary projection matrix, D^{H}, to obtain the one or more gradient indications. For example, the network entity may obtain the one or more gradient indication, W, as

$$W = {D}^{H} {\sum }_{n} {H}_{n , t 1} ( {H}_{n , t 0}^{- 1} {Dw}_{n} ) + {D}^{H} Z ,$$

as described with respect to FIG. 6. The vector W may include the plurality of gradient indications, as summed based on OTA summation. The network entity 702 may identify individual gradient indications (e.g., w₁ through wₙ) corresponding to individual subcarriers. Based on OTA summation, the network entity 702 may update a model parameter associated with each gradient, as described below.

As shown at 716, the network entity 702 may transmit, and the node 704 may receive, an indication of an updated model parameter. For example, the model parameter may be a weight or bias associated with the federated learning, and the network entity 702 may update the model parameter according to the one or more gradient indications. Thus, the network entity 702 and the node 704 perform federated learning with gradient indications that are spread (e.g., projected) over multiple signal components (e.g., subcarriers). Thus, the gradient indications transmitted via the signal may be rendered more resistant to variability between performance of individual subcarriers of subcarriers 1 through n.

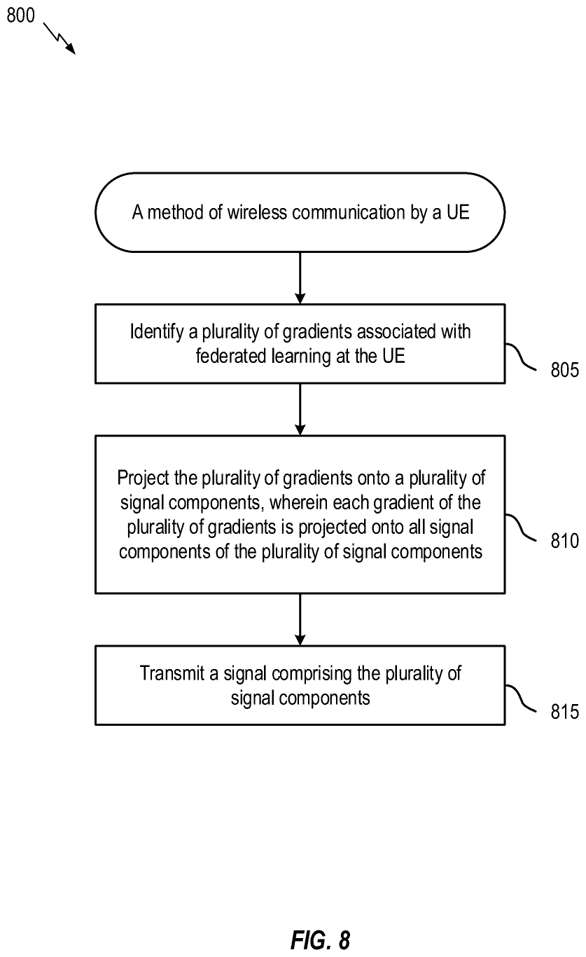

FIG. 8 shows a method 800 for wireless communication by a node, such as UE 104 of FIG. 1, UE 304 of FIG. 3, or edge device 502 of FIG. 5.

Method 800 begins at block 805 with identifying a plurality of gradients associated with federated learning at the node.

Method 800 then proceeds to block 810 with projecting the plurality of gradients onto a plurality of signal components, wherein each gradient of the plurality of gradients is projected onto all signal components of the plurality of signal components.

Method 800 then proceeds to block 815 with transmitting a signal comprising the plurality of signal components.

In some aspects, block 810 includes projecting the plurality of gradients using a unitary projection matrix.

In some aspects, method 800 further includes receiving, from a network entity, information indicating the unitary projection matrix.

In some aspects, the unitary projection matrix is specified in a wireless communication specification.

In some aspects, block 815 includes transmitting the signal in association with a network entity, wherein the unitary projection matrix is associated with the network entity.

In some aspects, the unitary projection matrix is a first unitary projection matrix and the method 800 further comprises transmitting, to a second network entity, a second signal comprising a second plurality of signal components generated using a second unitary projection matrix associated with the second network entity.

In some aspects, the unitary projection matrix is specific to a first set of layers of multiple layers, and wherein the signal comprises a second plurality of signal components generated using a second unitary projection matrix specific to a second set of layers of the multiple layers.

In some aspects, the unitary projection matrix is common to multiple layers.

In some aspects, block 810 further includes projecting the plurality of gradients such that each gradient, of the plurality of gradients, is evenly distributed over all signal components of the plurality of signal components.

In some aspects, each signal component of the plurality of signal components corresponds to a respective subcarrier of a plurality of subcarriers.

In some aspects, each signal component of the plurality of signal components is transmitted on the respective subcarrier of the plurality of subcarriers.

In some aspects, block 810 includes projecting the plurality of gradients onto a plurality of signal components based on a time difference between a channel estimation and transmitting the signal satisfying a threshold.

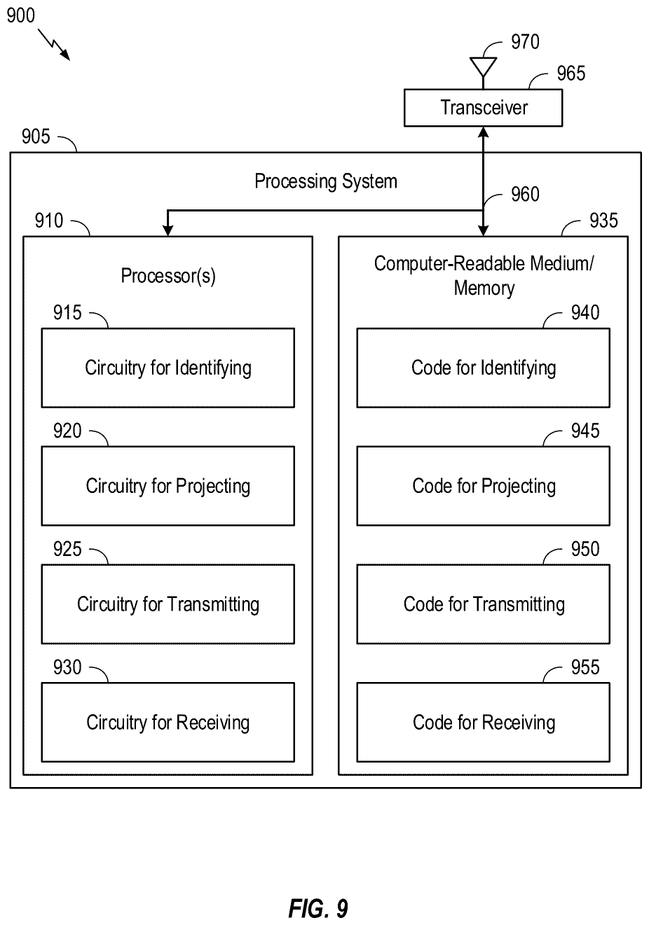

In some aspects, method 800, or any aspect related to it, may be performed by an apparatus, such as communications device 900 of FIG. 9, which includes various components operable, configured, or adapted to perform the method 800.

Communications device 900 is described below in further detail.

Note that FIG. 8 is just one example of a method, and other methods including fewer, additional, or alternative operations are possible consistent with this disclosure.

### Example Communications Device

FIG. 9 depicts aspects of an example communications device 900 configured for wireless communications. In some aspects, communications device 900 is a user equipment, such as UE 104 described above with respect to FIG. 1 or UE 304 described with respect to FIG. 3.

The communications device 900 includes a processing system 905 coupled to a transceiver 965 (e.g., a transmitter and/or a receiver). The transceiver 965 is configured to transmit and receive signals for the communications device 900 via an antenna 970, such as the various signals as described herein. The processing system 905 may be configured to perform processing functions for the communications device 900, including processing signals received and/or to be transmitted by the communications device 900.

The processing system 905 includes one or more processors 910 and a computer-readable medium/memory 935. In various aspects, the one or more processors 910 may be representative of the one or more processors 318 described with respect to FIG. 3. The one or more processors 910 are coupled to a computer-readable medium/memory 935 via a bus 960. In some aspects, the computer-readable medium/memory 935 may be representative of the one or more memories 320 described with respect to FIG. 3. The computer-readable medium/memory 935 is a non-transitory computer-readable medium/memory. In certain aspects, the computer-readable medium/memory 935 is configured to store instructions (e.g., computer-executable code), that when executed by the one or more processors 910, cause the one or more processors 910 to perform the method 800 described with respect to FIG. 8, or any aspect related to it, including any operations described in relation to FIG. 8. Note that reference to a processor performing a function of communications device 900 may include one or more processors performing that function of communications device 900, such as in a distributed fashion.

In the depicted example, computer-readable medium/memory 935 stores code (e.g., executable instructions), including code for identifying 940, code for projecting 945, code for transmitting 950, and code for receiving 955. Processing of the code 940-955 may enable and cause the communications device 900 to perform the method 800 described with respect to FIG. 8, or any aspect related to it. For example, in some aspects, code for identifying 940 includes code for identifying a plurality of gradients associated with federated learning at the UE. In some aspects, code for projecting 945 includes code for projecting the plurality of gradients onto a plurality of signal components, wherein each gradient of the plurality of gradients is projected onto all signal components of the plurality of signal components. In some aspects, code for transmitting 950 includes code for transmitting a signal comprising the plurality of signal components.

The one or more processors 910 include circuitry configured to implement (e.g., execute) the code stored in the computer-readable medium/memory 935, including circuitry for identifying 915, circuitry for projecting 920, circuitry for transmitting 925, and circuitry for receiving 930. Processing with circuitry 915-930 may enable and cause the communications device 900 to perform the method 800 described with respect to FIG. 8, or any aspect related to it. For example, in some aspects, circuitry for identifying 915 includes circuitry for identifying a plurality of gradients associated with federated learning at the UE. In some aspects, circuitry for projecting 920 includes circuitry for projecting the plurality of gradients onto a plurality of signal components, wherein each gradient of the plurality of gradients is projected onto all signal components of the plurality of signal components. In some aspects, circuitry for transmitting 925 includes circuitry for transmitting a signal comprising the plurality of signal components.

More generally, means for communicating, transmitting, sending or outputting for transmission may include the one or more transceivers 324, one or more antenna 322 and/or processing system 316 of the UE 304 illustrated in FIG. 3, transceiver 965 and/or antenna 970 of the communications device 900 in FIG. 9, and/or one or more processors 910 of the communications device 900 in FIG. 9. Means for communicating, receiving or obtaining may include the one or more transceivers 324, one or more antennas 322, and/or processing system 316 of the UE 304 illustrated in FIG. 3, transceiver 965 and/or antenna 970 of the communications device 900 in FIG. 9, and/or one or more processors 910 of the communications device 900 in FIG. 9.

### Example Clauses

Implementation examples are described in the following numbered clauses:

Clause 1: A method of wireless communication by a UE comprising: identifying a plurality of gradients associated with federated learning at the UE; projecting the plurality of gradients onto a plurality of signal components, wherein each gradient of the plurality of gradients is projected onto all signal components of the plurality of signal components; and transmitting a signal comprising the plurality of signal components.

Clause 2: The method of Clause 1, wherein projecting the plurality of gradients onto the plurality of signal components comprises projecting the plurality of gradients using a unitary projection matrix.

Clause 3: The method of Clause 2, further comprising: receiving, from a network entity, information indicating the unitary projection matrix.

Clause 4: The method of Clause 2, wherein the unitary projection matrix is specified in a wireless communication specification.

Clause 5: The method of Clause 2, wherein transmitting the signal comprises transmitting the signal in association with a network entity, wherein the unitary projection matrix is associated with the network entity.

Clause 6: The method of Clause 2, wherein the unitary projection matrix is a first unitary projection matrix and the method comprises transmitting, to a second network entity, a second signal comprising a second plurality of signal components generated using a second unitary projection matrix associated with the second network entity.

Clause 7: The method of Clause 2, wherein the unitary projection matrix is specific to a first set of layers of multiple layers, and wherein the signal comprises a second plurality of signal components generated using a second unitary projection matrix specific to a second set of layers of the multiple layers.

Clause 8: The method of Clause 2, wherein the unitary projection matrix is common to multiple layers.

Clause 9: The method of any one of Clauses 1-8, wherein projecting the plurality of gradients onto the plurality of signal components further comprises projecting the plurality of gradients such that each gradient, of the plurality of gradients, is evenly distributed over all signal components of the plurality of signal components.

Clause 10: The method of any one of Clauses 1-9, wherein each signal component of the plurality of signal components corresponds to a respective subcarrier of a plurality of subcarriers.

Clause 11: The method of Clause 10, wherein each signal component of the plurality of signal components is transmitted on the respective subcarrier of the plurality of subcarriers.

Clause 12: The method of any one of Clauses 1-11, wherein projecting the plurality of gradients onto a plurality of signal components comprises projecting the plurality of gradients onto a plurality of signal components based on a time difference between a channel estimation and transmitting the signal satisfying a threshold.

Clause 13: A method of wireless communication by a network entity, comprising: receiving, from a plurality of nodes, a signal comprising a plurality of signal components; obtaining, from the plurality of signal components and using an inverse of a unitary projection matrix, a plurality of gradients associated with federated learning at the plurality of nodes; updating a model parameter based on the plurality of gradients; and transmitting, to the plurality of nodes, an indication of the updated model parameter.

Clause 14: The method of Clause 13, further comprising transmitting, to the set of nodes, information indicating the unitary projection matrix.

Clause 15: The method of any of Clauses 13-14, wherein the unitary projection matrix is specified in a wireless communication specification.

Clause 16: The method of any of Clauses 13-15, wherein the unitary projection matrix is associated with the network entity.

Clause 17: The method of any of Clauses 13-16, wherein the unitary projection matrix is specific to a first set of layers of multiple layers, and wherein the signal comprises a second plurality of signal components generated using a second unitary projection matrix specific to a second set of layers of the multiple layers.

Clause 18: The method of any of Clauses 13-17, wherein the unitary projection matrix is common to multiple layers.

Clause 19: The method of any of Clauses 13-18, wherein each gradient, of the plurality of gradients, is evenly distributed over all signal components of the plurality of signal components.

Clause 20: The method of any of Clauses 13-19, wherein each signal component of the plurality of signal components corresponds to a respective subcarrier of a plurality of subcarriers.

Clause 21: The method of any of Clauses 13-20, wherein each signal component of the plurality of signal components is transmitted on the respective subcarrier of the plurality of subcarriers.

Clause 22: One or more apparatuses, comprising: one or more memories comprising executable instructions; and one or more processors configured to execute the executable instructions and cause the one or more apparatuses to perform a method in accordance with any one of Clauses 1-21.

Clause 23: One or more apparatuses configured for wireless communications, comprising: one or more memories; and one or more processors, coupled to the one or more memories, configured to cause the one or more apparatuses to perform a method in accordance with any one of Clauses 1-21.

Clause 24: One or more apparatuses configured for wireless communications, comprising: one or more memories; and one or more processors, coupled to the one or more memories, configured to perform a method in accordance with any one of Clauses 1-21.

Clause 25: One or more apparatuses, comprising means for performing a method in accordance with any one of Clauses 1-21.

Clause 26: One or more non-transitory computer-readable media comprising executable instructions that, when executed by one or more processors of one or more apparatuses, cause the one or more apparatuses to perform a method in accordance with any one of Clauses 1-21.

Clause 27: One or more computer program products embodied on one or more computer-readable storage media comprising code for performing a method in accordance with any one of Clauses 1-21.

Clause 28: One or more apparatuses configured for wireless communications, comprising: a processing system that includes one or more processors and one or more memories coupled with the one or more processors, the processing system configured to cause the one or more apparatuses to perform a method in accordance with any one of Clauses 1-21.

### Additional Considerations

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the general principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various actions may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The various illustrative logical blocks, modules and circuits described in connection with the present disclosure may be implemented or performed with a general purpose processor, an AI processor, a digital signal processor (DSP), an application specific integrated circuit (ASIC), a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, a SoC, a SiP, or any other such configuration.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

As used herein, “coupled to” and “coupled with” generally encompass direct coupling and indirect coupling (e.g., including intermediary coupled aspects) unless stated otherwise. For example, stating that a processor is coupled to a memory allows for a direct coupling or a coupling via an intermediary aspect, such as a bus.

The methods disclosed herein comprise one or more actions for achieving the methods. The method actions may be interchanged with one another without departing from the scope of the claims. In other words, unless a specific order of actions is specified, the order and/or use of specific actions may be modified without departing from the scope of the claims. Further, the various operations of methods described above may be performed by any suitable means capable of performing the corresponding functions. The means may include various hardware and/or software component(s) and/or module(s), including, but not limited to a circuit, an ASIC, or processor.

The following claims are not intended to be limited to the aspects shown herein, but are to be accorded the full scope consistent with the language of the claims. Reference to an element in the singular is not intended to mean only one unless specifically so stated, but rather “one or more.” The subsequent use of a definite article (e.g., “the” or “said”) with an element (e.g., “the processor”) is not intended to invoke a singular meaning (e.g., “only one”) on the element unless otherwise specifically stated. For example, reference to an element (e.g., “a processor,” “the processor,” etc.), unless otherwise specifically stated, should be understood to refer to one or more elements (e.g., “one or more processors,” or the like). The terms “set” and “group” are intended to include one or more elements, and may be used interchangeably with “one or more.” Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions. Unless specifically stated otherwise, the term “some” refers to one or more. All structural and functional equivalents to the elements of the various aspects described throughout this disclosure that are known or later come to be known to those of ordinary skill in the art are intended to be encompassed by the claims. Moreover, nothing disclosed herein is intended to be dedicated to the public regardless of whether such disclosure is explicitly recited in the claims.

What is claimed is:

1. An apparatus for wireless communications, comprising a processing system that includes one or more processors and one or more memories coupled with the one or more processors, the processing system configured to cause a node to:
identify a plurality of gradients associated with federated learning at the node;
project the plurality of gradients onto a plurality of signal components, wherein each gradient of the plurality of gradients is projected onto all signal components of the plurality of signal components; and
transmit a signal comprising the plurality of signal components.

2. The apparatus of claim 1, wherein to project the plurality of gradients onto the plurality of signal components, the processing system is configured to cause the node to project the plurality of gradients using a unitary projection matrix.

3. The apparatus of claim 2, wherein the processing system is further configured to cause the node to:
receive, from a network entity, information indicating the unitary projection matrix.

4. The apparatus of claim 2, wherein the unitary projection matrix is specified in a wireless communication specification.

5. The apparatus of claim 2, wherein to transmit the signal, the processing system is configured to cause the node to transmit the signal in association with a network entity, wherein the unitary projection matrix is associated with the network entity.

6. The apparatus of claim 2, wherein the unitary projection matrix is a first unitary projection matrix and the processing system is further configured to cause the node to transmit, to a second network entity, a second signal comprising a second plurality of signal components generated using a second unitary projection matrix associated with the second network entity.

7. The apparatus of claim 2, wherein the unitary projection matrix is specific to a first set of layers of multiple layers, and wherein the signal comprises a second plurality of signal components generated using a second unitary projection matrix specific to a second set of layers of the multiple layers.

8. The apparatus of claim 2, wherein the unitary projection matrix is common to multiple layers.

9. The apparatus of claim 1, wherein to project the plurality of gradients onto the plurality of signal components, the processing system is configured to cause the node to project the plurality of gradients such that each gradient, of the plurality of gradients, is evenly distributed over all signal components of the plurality of signal components.

10. The apparatus of claim 1, wherein each signal component of the plurality of signal components corresponds to a respective subcarrier of a plurality of subcarriers.

11. The apparatus of claim 10, wherein each signal component of the plurality of signal components is transmitted on the respective subcarrier of the plurality of subcarriers.

12. The apparatus of claim 1, wherein to project the plurality of gradients onto the plurality of signal components, the processing system is configured to cause the node to project the plurality of gradients onto the plurality of signal components based on a time difference between a channel estimation and transmitting the signal satisfying a threshold.

13. An apparatus for wireless communications, comprising a processing system that includes one or more processors and one or more memories coupled with the one or more processors, the processing system configured to cause a network entity to:
receive, from a plurality of nodes, a signal comprising a plurality of signal components;
obtain, from the plurality of signal components and using an inverse of a unitary projection matrix, a plurality of gradients associated with federated learning at the plurality of nodes;
update a model parameter based on the plurality of gradients; and
transmit, to the plurality of nodes, an indication of the updated model parameter.

14. The apparatus of claim 13, wherein the processing system is further configured to cause the network entity to:
transmit, to the plurality of nodes, information indicating the unitary projection matrix.

15. The apparatus of claim 13, wherein the unitary projection matrix is specified in a wireless communication specification.

16. The apparatus of claim 13, wherein the unitary projection matrix is associated with the network entity.

17. The apparatus of claim 13, wherein the unitary projection matrix is specific to a first set of layers of multiple layers, and wherein the signal comprises a second plurality of signal components generated using a second unitary projection matrix specific to a second set of layers of the multiple layers.

18. The apparatus of claim 13, wherein the unitary projection matrix is common to multiple layers.

19. The apparatus of claim 13, wherein each gradient, of the plurality of gradients, is evenly distributed over all signal components of the plurality of signal components.

20. One or more non-transitory computer-readable media comprising executable instructions that, when executed by one more processors of an apparatus, cause the apparatus to perform operations comprising:
identifying a plurality of gradients associated with federated learning at a user equipment (UE);
projecting the plurality of gradients onto a plurality of signal components, wherein each gradient of the plurality of gradients is projected onto all signal components of the plurality of signal components; and
transmitting a signal comprising the plurality of signal components.
